(19) United States
(12) Patent Application Publication
(10) Pub. No.: US 2026/0360246 A1
(43) Pub. Date: Nov. 12, 2026

(54) EVENT DETECTION METHOD

(71) Applicant: Endress+Hauser SE+Co. KG, Maulburg (DE)

(72) Inventors: Simon Zühlke, Schopfheim (DE); Pavo Vrdoljak, Nesselwang (DE)

(21) Appl. No.: 19/134,904

(22) PCT Filed: Nov. 14, 2023
(86) PCT No.: PCT/EP2023/081675

§ 371 Date: Jun. 2, 2025

(30) Foreign Application Priority Data
Dec. 6, 2022 (DE) 10 2022 132 383.8

(51) Int. Cl. G08B 21/10; G08B 21/18; G08B 31/00

(52) U.S. Cl. CPC G08B 21/10; G08B 21/182; G08B 31/00

(57) ABSTRACT

A detection method for detecting an environmental event includes the following steps: a) measuring at least two variables which are detected by at least one detection system that is arranged at a decentralized measuring point; b) transferring the measurement values of the at least two variables from the detection system to a data processing unit that is designed to execute a model for evaluating the current environmental conditions and/or for predicting the possibility of an environmental event occurring, wherein the correlation of the at least two variables, which is based upon cross-correlation, is measured.

The invention relates to a method for detecting an environmental event according to the preamble of claim 1 and to a system for performing the method.

Early warning systems provide information on areas vulnerable to specific environmental events such as natural disasters-for example, landslides, floods, earthquakes, unauthorized discharge of raw or inadequately treated wastewater into a zone in which no discharge is allowed, and illegal withdrawal of water. These environmental events can be life-threatening or harmful to the environment; so, accurate forecasting and warning are important.

Early warning systems often include measuring transducers, event detection subsystems, and decision subsystems, to identify hazards at an early stage. Historical data and predictive models are often used to detect such events. For example, to predict a flooding event, precipitation data is continuously fed into a model. The simulation results are then displayed as flow-and water-level forecasts at predefined, desired locations.

Typically, these event detection methods are based upon a single measured quantity/variable. Although some methods are based upon more than one variable, they often do not provide the relationship between the variables. Therefore, their capabilities in terms of warning and prediction/forecasting are limited.

The object of the present invention is to provide a more detailed and precise prediction/forecasting method for environmental events.

The object is achieved by the method specified in independent claim 1 and by the system for performing the method described in claim 10.

With regard to the method, the object is achieved by means of the following steps: a) measuring at least two variables that are detected by at least one detection system that is arranged at a decentralized measuring point; b) transferring the measurement values of the at least two variables from the detection system to a data processing unit that is designed to execute a model for evaluating the current environmental conditions and/or for predicting the possibility of an environmental event occurring. The method is characterized in that the correlation of the at least two variables, which is based upon cross-correlation, is measured. Cross-correlation is a measure, often used in signal processing, of the similarity of two data series as a function of their shift relative to each other.

Advantageously, the at least two variables are measured continuously in a predefined measurement interval.

In one embodiment, the detection system comprises at least one of the following: a measuring transducer, a measuring apparatus, a geographic information system (GIS) model, a web service, and/or a database.

In one embodiment, the data processing unit is part of the detection system.

In one embodiment, the data processing unit is located in a central station for remote monitoring, in order to be protected from damage during the environmental event.

In one embodiment, the model comprises a simulation based upon artificial intelligence methods.

In one embodiment, the model is trained based upon historical measurement values of the at least two variables.

In one embodiment, the at least two variables comprise at least two of the following: soil moisture, water level, pressure level/groundwater pressure level (or pressure), water temperature, pH value, conductivity, turbidity, flow rate, oxygen content, nitrite content, soil bearing capacity and/or other ion concentration data, geological data, geographical data, climate data, weather data, weather forecast data.

In one embodiment, the environmental event comprises at least one of the following: a flood, a landslide, an unauthorized discharge/withdrawal of water, and/or an upstream chemical accident.

This object is further achieved by a system comprising at least one detection system that is arranged at a decentralized measuring point, and by a data processing unit that is designed to execute a model for evaluating the current environmental conditions and/or for predicting the possibility of an environmental event occurring, in order to perform the method described above.

This is explained in more detail with reference to the following FIGURE.

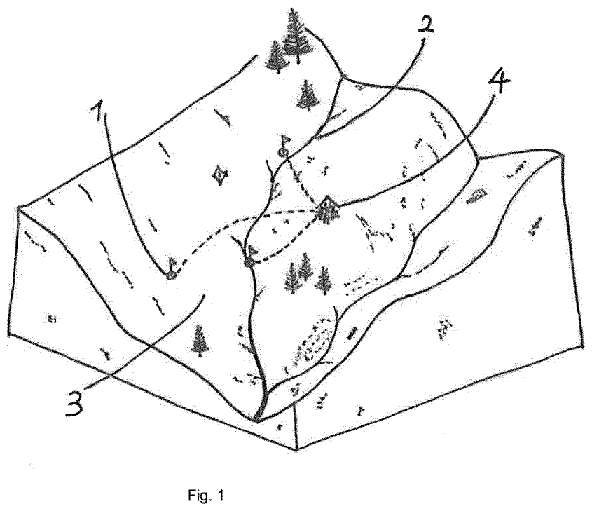

FIG. 1 shows an embodiment of the claimed measuring system.

In FIG. 1, the same features are marked with the same reference signs.

With reference to FIG. 1, the method is used to detect/predict a flooding event, a landslide event, or other natural disasters. A detection system 1 (e.g., a field device) comprises at least one measuring transducer located at a measuring point near a river 2 (could also be other bodies of water, such as a lake, a reservoir) or on a slope 3 (e.g., to detect a landslide event), wherein the detection system 1 measures two variables (m, n): soil moisture and water level. However, the variables could also be at least one of the following: pressure level/groundwater pressure level (or pressure), water temperature, flow rate, soil bearing capacity and/or other geological data, geographical data, climate data, weather data, weather forecast data (differentiation of rain/snow). The two variables (m, n) are then measured continuously in a predefined measurement interval. The measurement values (mₜ, nₜ) of the two variables are then transferred to a data processing unit 4 that is designed to execute a model for evaluating the current risk of flooding and/or for predicting the possibility of a flooding event occurring.

The data processing unit 4 is located in a central station for remote monitoring, which is connected to the detection system 1 by wire or wirelessly. The model comprises methods based upon AI (artificial intelligence) (e.g., anomaly detection) that are trained based upon the historical measurement values for the two variables (m, n). The model is improved using cross-correlation. In particular, the model is used to test whether the two variables (m, n) are correlated and, if so, to test the time delay between the two sets of variables (m, n). High soil moisture can indicate a high probability of flooding or landslide events. When abnormal water levels are detected, this is often a sign of flooding or a landslide. The correlation and time delay between the two sets of variables (m, n) could improve the detection method by providing a more detailed and accurate prediction.

Another implementation of the invention is a method for detecting unauthorized discharge/withdrawal of water and/or predicting what has happened upstream. A detection system 1 comprises two measuring transducers arranged at a measuring point in a river that measures two variables (m, n): water level and water temperature. However, other variables could also be used for the method, such as soil moisture, pressure level/groundwater pressure level (or pressure), flow rate, water temperature, pH value, conductivity, turbidity, oxygen content, nitrite content and/or other ion concentration data, climate data, weather data, weather forecast data (differentiation of rain/snow). The two variables (m, n) are then measured continuously in a predefined measurement interval. The measurement values (mₜ, nₜ) of the two variables are then transferred to a data processing unit 4 that is designed to execute a model for evaluating the current water conditions, for detecting an unauthorized discharge/withdrawal of water, and/or for predicting the possibility of an upstream chemical accident.

The data processing unit 4 could be a computer in a central station for remote monitoring. The model comprises methods based upon AI (artificial intelligence) (e.g., anomaly detection) that are trained based upon the historical measurement values of the two variables (m, n). An abnormal water level or water temperature can indicate unauthorized discharge/withdrawal of water. The model is then improved using cross-correlation. In particular, the model is used to test whether the two variables (m, n) are correlated and, if so, to test the time delay between the two sets of variables (m, n).

### LIST OF REFERENCE SIGNS

1 Detection system
2 River
3 Slope
4 Data processing unit

1-10. (canceled)

11. A method for detecting an environmental event, the method comprising:
measuring measurement values of at least two variables detected by at least one detection system, which is disposed at a decentralized measuring point;
transferring the measurement values of the at least two variables from the at least one detection system to a data processing unit configured to execute a model for evaluating current environmental conditions and/or for predicting a possibility of an occurrence of an environmental event,
wherein a correlation between the at least two variables, which is based upon cross-correlation, is measured.

12. The method according to claim 11, wherein the at least two variables are measured continuously in a predefined measurement interval.

13. The method according to claim 11, wherein the at least one detection system comprises at least one of a measuring transducer, a measuring apparatus, a web service, and a database.

14. The method according to claim 11, wherein the at least one detection system comprises a model of a geographical information system.

15. The method according to claim 11, wherein the at least one detection system includes the data processing unit.

16. The method according to claim 11, wherein the at least one data processing unit is in a central station for remote monitoring.

17. The method according to claim 11, wherein the model comprises a simulation based upon artificial intelligence methods.

18. The method according to claim 11, wherein the model is trained based upon historical measurement values of the at least two variables.

19. The method according to claim 11, wherein the at least two variables include at least two of: soil moisture, water level, pressure level/groundwater pressure level, pressure, water temperature, pH value, conductivity, turbidity, flow rate, oxygen content, nitrite content, soil bearing capacity, soil ion concentration data, geological data, geographical data, climate data, weather data, and weather forecast data.

20. The method according to claim 11, wherein the environmental event includes at least one of: a flood, a landslide, an unauthorized discharge or withdrawal of water, and an upstream chemical accident.

21. The method according to claim 11, wherein the correlation includes a time delay between relative shifts of the at least two variables.

22. A system for performing the method according to claim 11, the system comprising:
at least one detection system arranged at a decentralized measuring point; and
a data processing unit configured to execute a model for evaluating current environmental conditions and/or for predicting the possibility of an environmental event occurring.
